(19) United States
(12) Patent Application Publication
(10) Pub. No.: US 2025/0363708 A1
(43) Pub. Date: Nov. 27, 2025

(54) IMAGE PROCESSING APPARATUS, CONTROL METHOD OF IMAGE PROCESSING APPARATUS, AND RECORDING MEDIUM

(71) Applicant: CANON KABUSHIKI KAISHA, Tokyo (JP)

(72) Inventor: YASUHIKO IWAMOTO, Tokyo (JP)

(21) Appl. No.: 19/194,793

(22) Filed: Apr. 30, 2025

(30) Foreign Application Priority Data
May 24, 2024 (JP) 2024-084841

(51) Int. Cl. G06T 15/00; G02B 27/01; G06T 5/50; G06V 10/25; G06V 10/56; H04N 1/60

(52) U.S. Cl. CPC G06T 15/00; G02B 27/0172; G06T 5/50; G06V 10/25; G06V 10/56; H04N 1/60; G06T 2207/20221; G06V 2201/07

(57) ABSTRACT

An image processing apparatus capable of allowing a user to visually perceive an image by transmitting external light comprises an imaging unit configured to capture an image of an external world; a region extraction unit configured to extract a specific region from an external-world image acquired by imaging by the imaging unit; a virtual image generation unit configured to generate a virtual image for correcting a vision of a user for the specific region; and a virtual image display unit configured to display the virtual image so as to be superimposed on a region corresponding to the specific region of the transmitted external light, wherein the region extraction unit extracts the subject region as a specific region by detecting a subject region corresponding to a predetermined subject from the external image, and wherein the virtual image generation unit generates a virtual image for correcting the identifiability of the predetermined subject based on pixel information of the specific region and a dark night vision correction coefficient.

### BACKGROUND OF THE INVENTION

### Field of the Invention

The present invention relates to an image processing apparatus that transmits external light.

### Description of the Related Art

Conventionally, there are various apparatuses for assisting vision. In recent years, Augmented Reality (hereinafter, referred to as “AR”) technology for displaying a virtual space superimposed on a real space has been attracting attention. Among AR apparatus, there are AR apparatuses that are realized by an optical see-through type head-mounted display that transmits external light (hereinafter, referred to as an “HMD”).

Additionally, as an apparatus for assisting vision, for example, there is chromatic vision correction glasses for a user who has a handicap in chromatic vision. In chromatic vision correction glasses, chromatic vision is corrected by blocking light of colors (for example, green and blue) that is other than a color with low sensitivity to the extent of light of a color with low sensitivity (for example, red). Japanese Patent Application Laid-Open No. 2016-057621 discloses a display apparatus that receives dyschromatopsia characteristic information of a user and controls a light emitting element using generated correction data. Additionally, at night and the like when there is no light source, even a user who does not have a handicap in chromatic vision has difficulty in visual perception. There is a night vision apparatus that collects and displays ambient light such as infrared rays in a dark environment such as at night when there is no light source.

However, in the chromatic vision correction glasses, since light is shielded to match colors with low sensitivity, the entire glasses are strongly shielded depending on the low sensitivity, which may cause the entire field of vision to become dark. Additionally, the display device disclosed in Japanese Patent Application Laid-Open No. 2016-057621 is a non-transmissive display device, and the technology disclosed in Japanese Patent Application Laid-Open No. 2016-057621 cannot be applied to an optical see-through type of HMD. Additionally, although the night vision apparatus can obtain a certain field of view, color information may be lost because visible light is not observed, or a part of the field of view may be overexposed in a situation in which light and dark are mixed, and thus identifiability decreases. Even in an optical see-through type of HMD that transmits external light, it is necessary to improve chromatic vision of a person who has a chromatic vision characteristic that is different from a normal chromatic vision characteristic and it is necessary to improve a decrease in identifiability due to a lack of color information in night vision.

### SUMMARY OF THE INVENTION

In the present invention, visual correction is performed in an image processing apparatus that transmits external light.

An image processing apparatus of the present invention is An image processing apparatus capable of allowing a user to visually perceive an image by transmitting external light comprises at least one processor and/or circuit configured to function as following units: an imaging unit configured to capture an image of an external world; a region extraction unit configured to extract a specific region from an external-world image acquired by imaging by the imaging unit; a virtual image generation unit configured to generate a virtual image for correcting a vision of a user for the specific region; and a virtual image display unit configured to display the virtual image so as to be superimposed on a region corresponding to the specific region of the transmitted external light, wherein the region extraction unit extracts the subject region as a specific region by detecting a subject region corresponding to a predetermined subject from the external image, and wherein the virtual image generation unit generates a virtual image for correcting the identifiability of the predetermined subject based on pixel information of the specific region and a night vision correction coefficient.

Further features of the present invention will become apparent from the following description of exemplary embodiments with reference to the attached drawings.

### BRIEF DESCRIPTION OF THE DRAWINGS

FIG. 1 is a diagram illustrating a configuration of an image processing apparatus 100.

FIG. 2 is a diagram illustrating a configuration of a near-eye unit 101 according to the first embodiment.

FIG. 3A and FIG. 3B are diagrams illustrating a pixel array of an imaging part 209.

FIG. 4 is a diagram illustrating a configuration of a control unit 105.

FIG. 5 is a diagram illustrating an overall configuration of a CNN in a subject detection unit 405.

FIG. 6 is a diagram illustrating a partial configuration of the CNN in the subject detection unit 405.

FIG. 7 is a flowchart illustrating the dimming processing.

FIG. 8A and FIG. 8B are explanatory views of an example of virtual image information generation in the first embodiment.

FIG. 9A to FIG. 9D are diagrams illustrating an application example of chromatic vision correction according to the first embodiment.

FIG. 10A and FIG. 10B are diagrams illustrating an example of virtual image information generation according to the second embodiment.

FIG. 11A to FIG. 11C are diagrams illustrating an application example of night vision correction according to the second embodiment.

FIG. 12 is a diagram illustrating an example of an overall configuration of the CNN in the subject detection unit 405 according to the third embodiment.

FIG. 13 is a diagram illustrating a configuration of the near-eye unit 101 according to the third embodiment.

FIG. 14 is a diagram illustrating a configuration of an imaging unit 1206 according to the third embodiment.

FIG. 15 is an explanatory view of the calculation of a parallax amount according to the third embodiment.

### DESCRIPTION OF THE EMBODIMENTS

### First Embodiment

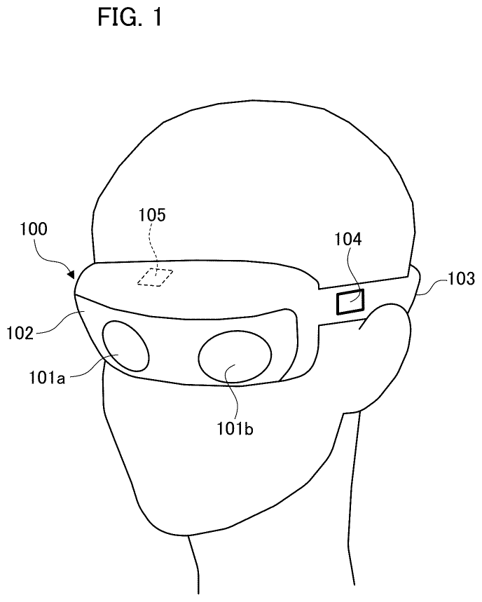

In the first embodiment, as vision correction, the dimming processing by chromatic vision correction in an image processing apparatus that transmits external light will be explained. In the image processing apparatus of the present embodiment, it is assumed that the three optical axes of the optical axis of the imaging of the external light, the optical axis of the vision of the external light, and the optical axis of the output of the virtual image light are arranged to be identical. FIG. 1 is a diagram illustrating a configuration of an image processing apparatus 100. The image processing apparatus 100 is an optical see-through type head-mounted display (HMD) that is mounted on the head of a human body and transmits external light. The image processing apparatus 100 is provided with an optical see-through configuration capable of allowing a user to visually perceive image light by a virtual image without hindering visual perception of external light. Note that the image processing apparatus 100 may be smart glasses that support rendering of a virtual object in AR.

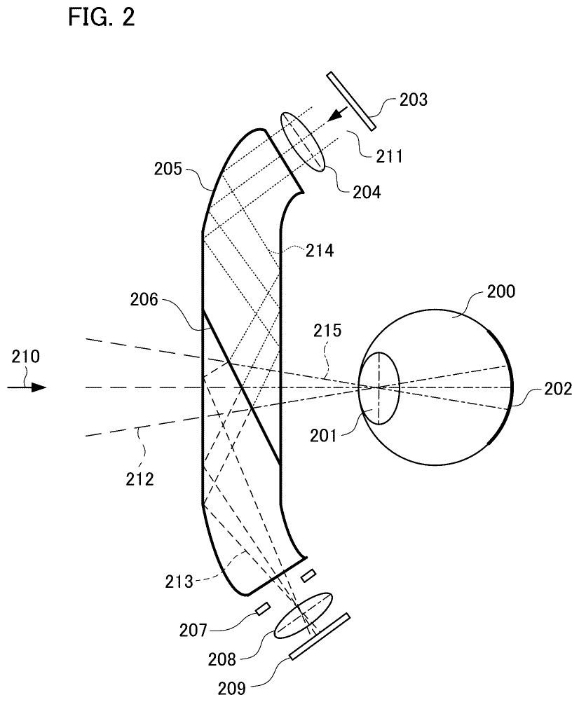

The image processing apparatus 100 is provided with the near-eye unit 101, a shield 102, a frame portion 103, and the control unit 105. The image processing apparatus 100 may include an operation portion 104. The near-eye unit 101 includes a near-eye unit 101a and a near-eye unit 101b. The near-eye unit 101a is disposed in front of the right eye of the human body and the near-eye unit 101b is disposed in front of the left eye of the human body, thereby allowing the user to have binocular vision. The near-eye units 101a and 101b have the same configuration except that their arrangement is different for the right eye and the left eye. Details of the configurations of the near-eye units 101a and 101b will be described below with reference to FIG. 2.

The shield 102 is a protective member that holds the near-eye unit 101a and the near-eye unit 101b at the front of the image processing apparatus 100 and prevents both units from being damaged or soiled. The shield 102 is formed of a transparent material. The frame portion 103 is a member for mounting the image processing apparatus 100 on the head of the user. Although the frame portion 103 is, for example, a head-mounted portion having a frame shape, the frame portion 103 may have any shape provided that it can be suitably mounted on the head of the user.

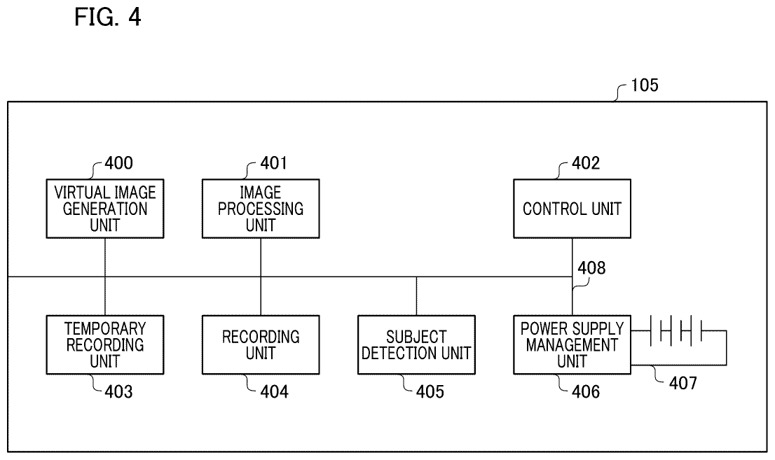

The control unit 105 serves as a control unit that controls the entire image processing apparatus 100. Although in FIG. 1, an example in which the control unit 105 is enclosed inside the frame portion 103 is illustrated, the present invention is not limited thereto. For example, the control unit 105 may be configured to be disposed outside the frame portion 103 and connected to each portion by a cable and the like. Details of the configuration of the control unit 105 will be described below with reference to FIG. 4.

The operation portion 104 is a member that receives an operation from a user. The operation portion 104 includes a plurality of members disposed in the frame portion 103. The operation portion 104 may be configured in any member provided that the operation portion 104 can appropriately receive an operation from the user in various processes to be described below. For example, the operation unit 104 may be four physical selection buttons of up, down, left, and right and one physical determination button that can be operated by the user with a finger. Alternatively, the image processing apparatus 100 may not include the operation portion 104, and another terminal having the function of the operation portion 104 may communicate with the image processing apparatus 100 to control the image processing apparatus 100. The user can change various parameters of the entire image processing apparatus 100 by operating the operation portion 104 while viewing menus, indicators, and the like displayed on the near-eye units 101a and 101b.

Next, a detailed configuration of the near-eye unit 101 (near-eye unit 101a and near-eye unit 101b) will be explained. FIG. 2 is a diagram illustrating the configuration of a near-eye unit 101 according to the first embodiment. FIG. 2 illustrates a schematic cross-sectional view of the near-eye unit 101 as viewed from a temporal region of a human body and an eyeball of a user of the image processing apparatus 100. The eyeball 200 is an eyeball of a user. An iris and a lens 201 are the iris and lens of the user. A retina 202 is a retina of the user.

The near-eye unit 101 is provided with a virtual image display portion 203, a virtual image adjustment portion 204, a light guide portion 205, an optical path control portion 206, a light amount adjustment portion 207, an optical system 208, and the imaging part 209. The virtual image display portion 203 is an output unit that emits virtual image light 211 (light emitting unit). The virtual image display portion 203 is, for example, a liquid crystal display (LCD). The luminous flux of the virtual image light 211 becomes linearly polarized light and is emitted from the virtual image display portion 203. The virtual image display portion 203 performs dimming operation by emitting light of at least one or more wavelengths. The virtual image display portion 203 can emit virtual image light having sufficient intensity for performing visual correction to be described below within a safe range for an eyeball of a user. The virtual image adjustment portion 204 performs focus adjustment control of the luminous flux of the virtual image light 211 that is emitted from the virtual image display portion 203. The virtual image adjustment portion 204 is, for example, a focus lens.

The light guide portion 205 is a light guide path having a plurality of eccentric reflection surfaces having a plurality of eccentric curvatures. The light guide portion 205 has a prism body using a plurality of internal reflections. The optical path control portion 206 is disposed inside the light guide unit 205 and has an eccentric curvature. The reflection surface of the optical path control portion 206 on the external side is a half mirror having predetermined reflectance and transmittance. The reflection surface of the optical path control portion 206 on the eyeball side of the user is a full mirror having a high reflectance.

The light amount adjustment portion 207, the optical system 208, and the imaging part 209 configure an imaging unit for imaging the external light. The light amount adjustment portion 207 is a diaphragm that adjusts an amount of light that enters the imaging part 209. The light amount adjustment portion 207 adjusts the amount of the external light divided by the optical path control portion 206 and guided by the light guide unit 205 that enters the imaging part 209 via the optical system 208. The optical system 208 performs focus adjustment control when external light forms an image on the imaging part 209. The optical system 208 is, for example, a focus lens.

The imaging part 209 is an imaging unit that images external light. The imaging part 209 is, for example, a CMOS sensor. The imaging part 209 includes a photoelectric conversion element that photoelectrically converts the external light imaged by the optical system 208 into an electric signal (light receiving element). The imaging part 209 includes, for example, a light receiving element having m pixels in the horizontal direction and n pixels in the vertical direction. The imaging part 209 also serves as a measurement unit together with an imaging unit. Two photoelectric conversion elements (light receiving regions) are arranged in each light receiving element of each pixel of the imaging part 209. The image formed on the imaging part 209 and photoelectrically converted is formed as an image signal (image data) by an image processing unit 401 to be described below. By adding the outputs of the two photoelectric conversion elements, an image of the imaging plane (captured image) can be acquired. Additionally, it is possible to acquire two images (parallax images) having parallax corresponding to each of the outputs of the two photoelectric conversion elements. Hereinafter, in the explanation of the present embodiment, the captured image obtained by adding the outputs of the two photoelectric conversion elements is also referred to as a A+B image, and the parallax images that are the outputs of the two photoelectric conversion elements are respectively also referred to as an A image and a B image. Additionally, it is desirable that the imaging part 209 has high sensitivity and low noise so as to be able to capture an image from which a subject can be detected by the subject detection unit 405 to be described below even under low-light conditions in which it is difficult to identify a subject with the naked eye.

Here, optical paths of external light 210 and the virtual image light 211 controlled by the near-eye unit 101 will be explained. First, the optical path of the external light 210 will be explained by taking, as an example, a case in which the external light enters the near-eye unit 101 via an optical path 212. When passing through the optical path 212, the external light 210 enters the light guide unit 205 of the near-eye unit 101. The external light that has entered the light guide unit 205 is divided into two parts by the optical path control unit 206, which is a half mirror, wherein a part of the external light is reflected and a part of the external light is transmitted. The external light reflected by the optical path control portion 206 is emitted from the light guide unit 205 via an optical path 213. The light amount of the external light emitted from the light guide unit 205 is adjusted by the light amount adjustment portion 207, the light is refracted by the optical system 208 to form an image on the imaging part 209. In contrast, the external light that has been transmitted through the optical path control portion 206 is incident on the eyeball 200 of the user via an optical path 215. The external light incident on the eyeball 200 of the user is refracted by the iris and the lens 201 to form an image on the retina 202, whereby the user visually perceives the external light. Thus, a part of the external light is guided to the imaging part 209 in the near-eye unit 101 and imaged, and a part of the external light is transmitted through the near-eye unit 101 and visually perceived by the user.

Next, an optical path of the virtual image light 211 that is dimmed for partially performing the visual correction will be explained. After the focus adjustment control is performed by the virtual image adjustment portion 204, the virtual image light 211 emitted from the virtual image display portion 203 enters the light guide unit 205. The light that has entered the light guide unit 205 is reflected by the optical path control portion 206 via an optical path 214, and is incident on the eyeball 200 of the user via the optical path 215. At this time, the virtual image light reflected by the optical path control portion 206 has the same optical axis as the external light transmitted through the optical path control portion 206 and the reflected light is incident on the eyeball 200 of the user via the optical path 215. The light incident on the eyeball 200 of the user is refracted by the iris and the lens 201 to form an image on the retina 214, whereby the user visually perceives a virtual image.

Thus, all of the external light 210 visually perceived by the naked eye 200, the external light 210 captured by the imaging part 209, and the virtual image light 211 displayed by the virtual image display portion 203 all have the same optical axis, resulting in a structure without parallax. Therefore, the configuration is suitable for calculation of a correction region to be described below. It should be noted that the configuration illustrated in FIG. 2 explained in the present embodiment is an example, and any optical see-through configuration capable of superimposing external light and virtual image light with high precision may be used, and the configuration is not limited thereto.

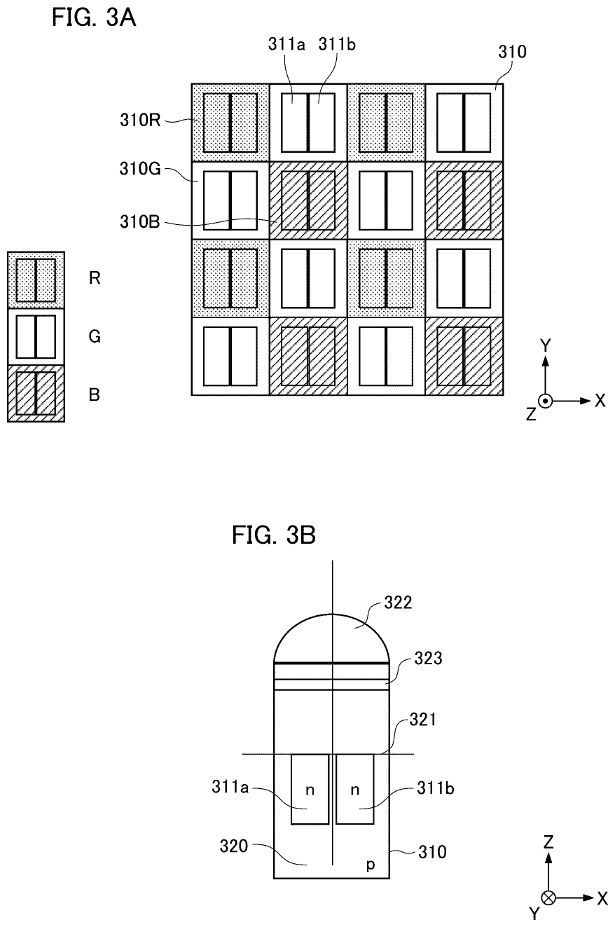

Next, a pixel structure of the imaging part 209 will be explained. FIG. 3A and FIG. 3B are diagrams illustrating a structure of pixels of the imaging part 209. FIG. 3A is a diagram illustrating a pixel array of the imaging part 209. In the imaging part 209, pixels 310 are arranged two-dimensionally. FIG. 3A illustrates a pixel range of 4 rows×4 columns among the pixels 310 of the imaging part 209. The array of the pixels 310 is, for example, a Bayer array. In the Bayer array, as two pixels in a diagonal direction, pixels 310G having spectral sensitivities of G (green) are arranged. Additionally, as the other two pixels, a pixel 310R having a spectral responsivity of R (red) and a pixel 310B having a spectral responsivity of B (blue) are arranged. In FIG. 3A, the pixel 310G is shown in white, the pixel 310R is shown in gray, and the pixel 310B is shown by oblique lines.

Each pixel 310 indicated by a square has sub-pixels (a sub-pixel 311a and a sub-pixel 311b) corresponding to two photoelectric conversion elements for pupil division indicated by rectangles. The sub-pixel 311a is a first pixel that receives a light flux that has passed through the first pupil region of the imaging optical system. Additionally, the sub-pixel 311b is a second pixel that receives a light flux that has passed through a second pupil region of the imaging optical system. The first pixel corresponds to the A image. The second pixel corresponds to the B image. Each pixel functions as an imaging pixel and a focus detection pixel.

In FIG. 3A, a plane parallel to the paper surface is defined as an X-Y plane, and an axis perpendicular to the paper surface is defined as a Z-axis. The pixels 310 are arranged two dimensionally in the X-Y plane. The Z-axis is parallel to the imaging optical axis of the imaging part 209, and a direction toward the top of the paper is defined as a positive direction. The sub-pixel 311a and the sub-pixel 311b are arranged along the X-axis direction.

FIG. 3B is a cross-sectional view of the pixel 310G taken along the Z-X plane. In FIG. 3B, the X-Z plane is parallel to the paper surface, and the Y-axis is perpendicular to the paper surface. Each of the sub-pixel 311a and the sub-pixel 311b has an independent pn-junction photodiode, and is configured by a p-type layer 320 and an n-type layer divided into two. As necessary, the p-type layer and the n-type layers may be formed as a pin structure photodiode by interposing an intrinsic layer. A micro lens 322 is disposed at a position separated from the light receiving surface 311 by a predetermined distance in the positive direction of the Z-axis direction. The micro lens 322 is formed on a color filter 323. One micro lens 322 is disposed on the front side (light incident side) with respect to the two photoelectric conversion units (the sub-pixel 311a and the sub-pixel 311b) configuring the pixel 310. A region sharing one micro lens 322 is one pixel.

The light entered into the pixel 310 is collected by the micro lens 322, and after being spectrally divided by the color filter 323, is then received by each of the sub-pixel 311a and the sub-pixel 311b. In each sub pixel, a pair of an electron and a hole (positive hole) is generated according to the amount of received light, and the electrons are accumulated after being separated by a depletion layer. In contrast, the holes are discharged to the outside of the imaging element through the p-type layer that is connected to the constant voltage source. The electrons accumulated in the sub-pixel 311a and the sub-pixel 311b are transferred to the capacitance portion (FD) via the transfer gate and converted into voltage signals.

In the present embodiment, the sub-pixels 310R and 310G for pupil division are provided in all the pixels 310B, 311a, and 311b of the imaging part 209. The sub-pixels 311a and 311b are used as focus detection pixels. However, the present embodiment is not limited thereto, and a configuration may be adopted in which focus detection pixels capable of pupil division are provided only in some of all the pixels. Additionally, in the present embodiment, although a configuration example in which two photodiodes are arranged with respect to one micro lens is described, a configuration in which three or more (four, nine, and the like) photodiodes are arranged with respect to one micro lens may be adopted. For example, the present invention is also applicable to a configuration in which a plurality of photodiodes are arranged in the upper and lower direction or the right and left direction with respect to one micro lens.

Next, a configuration of the control unit 105 will be explained with reference to FIG. 4. The control unit 105 includes a virtual image generation unit 400, the image processing unit 401, a control unit 402, a temporary recording unit 403, a recording unit 404, the subject detection unit 405, a power supply management unit 406, a power supply unit 407, and a bus 408. The virtual image generation unit 400 is a generation unit that generates an image to be output by the virtual image display portion 203 and displayed on the near-eye unit 101. The image generated by the virtual image generation unit 400 includes an image for correcting vision by being superimposed on an image of the external world, and a virtual image. The virtual image is, for example, a menu, an indicator, and the like for assisting an operation using the operation portion 104, information indicating a situation of the external world and a situation of the image processing apparatus 100 obtained from the imaging part 209, and the like. A generation method of an image for correcting vision by superimposing the image on the image of the external world generated by the virtual image generation unit 400 of the present embodiment will be described below.

The image processing unit 401 performs various types of image processing on the input digital image signal. The image processing performed by the image processing unit 401 includes gamma correction, white balance processing, noise removal, demosaicing, aberration correction, color correction, and the like. The image processing performed by the image processing unit 401 includes region extraction processing for extracting a specific region. The image processing unit 401 that performs the region extraction processing functions as a region extraction unit. In addition, the image processing performed by the image processing unit 401 also includes a process of generating a captured image from parallax images.

The image signal input to the image processing unit 401 is image data captured by the imaging part 209 and output. The image processing unit 401 can acquire two images having different parallax (parallax images, the A image, and the B image) by handling the outputs of the two photoelectric conversion elements. Additionally, the image processing unit 401 can acquire an image of the imaging surface (captured image, A+B image) by adding the outputs of the two photoelectric conversion elements. Furthermore, the image processing unit 401 generates a defocus map based on the parallax image. A known method such as a pupil division type phase difference detection method may be used for generating the defocus map. For example, a method disclosed in Japanese Patent Application Laid-Open No. 2016-156934 is used in the image processing unit 401 to generate a plurality of defocus maps in which minute blocks in which correlation calculation is performed are different. The defocus map is a map including a defocus amount for each pixel, and the defocus amount is represented by a unit of Fδ. The distance from the imaging element to a specific region can be measured based on the defocus map.

The control unit 402 executes various programs and controls the processing of the entire image processing apparatus 100. The control unit 402 is, for example, a central processing unit (CPU). The control unit 402 corresponds to a determination unit in Claims. The temporary recording unit 403 records data that needs to be temporarily recorded according to the control of the entire image processing apparatus 100. The temporary recording unit 403 is, for example, a random access memory (RAM). The temporarily recorded data is, for example, image data output from the imaging part 209.

The recording unit 404 is a recording unit that records data that needs to be recorded for a long period of time in accordance with control of the entire image processing apparatus 100. The recording unit 404 is, for example, a flash memory. The data recorded in the recording unit 404 includes, for example, a control program necessary for controlling the image processing apparatus 100, parameters used for the operation of each unit, chromatic vision characteristic information, a machine learning (ML) dictionary that is applicable to the subject detection unit 405, and the like. When the image processing apparatus 100 is activated by the operation of the power supply by the user, the control program and the parameters that are stored in the recording unit 404 are read into the temporary recording unit 403. The control unit 402 controls the operation of the image processing apparatus 100 according to the control program and constants loaded into the temporary recording unit 403. The recording unit 404 records chromatic vision characteristic information for each user. Additionally, the ML dictionary stored in the recording unit 404 is applied to the subject detection unit 405.

Here, the chromatic vision characteristic information will be explained. The chromatic vision characteristic information includes the sensitivity of the user to each element of the color space handled by the image processing apparatus 100. For example, in a case in which the color space handled by the image processing apparatus 100 is RGB, sensitivity for each of R, G, and B related to the eyeball of the user is included in the chromatic vision characteristic information. The sensitivity is represented, for example, by a value between 1 and 0, and in a case in which sensitivity for each of R, G, and B is 1, the sensitivity indicates normal chromatic vision. Additionally, a sensitivity of less than 1 indicates that the sensitivity for the corresponding color element is low. Regarding sensitivity, as the value is closer to 0, the sensitivity is lower. For example, in a case in which the sensitivity of G and B is 1 and the sensitivity of R is 0.5, it is assumed that the sensitivity to red is low and is 0.5 times the sensitivity to green and blue. It should be noted that expressing the color vision characteristic information as sensitivity for each of R, G, and B by a value from 0 to 1 is an example and is not limited thereto. It suffices if the chromatic vision characteristic information is a value representing the sensitivity of the user to each element of the color space. In the present embodiment, the chromatic vision characteristic information is recorded in the recording unit 404 for each user.

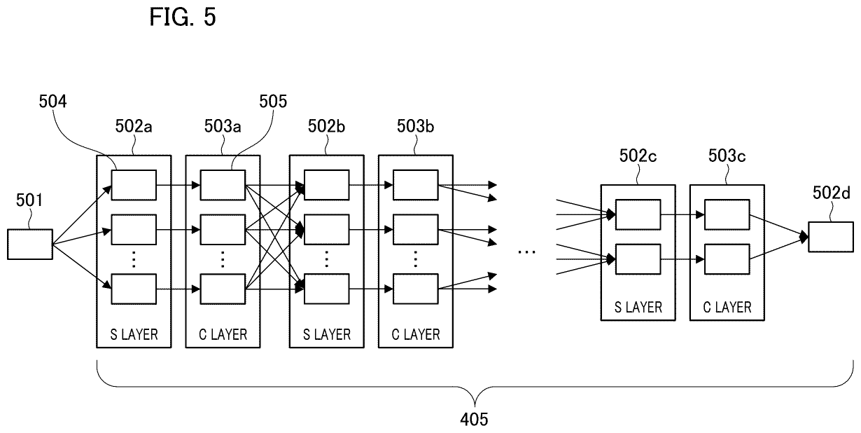

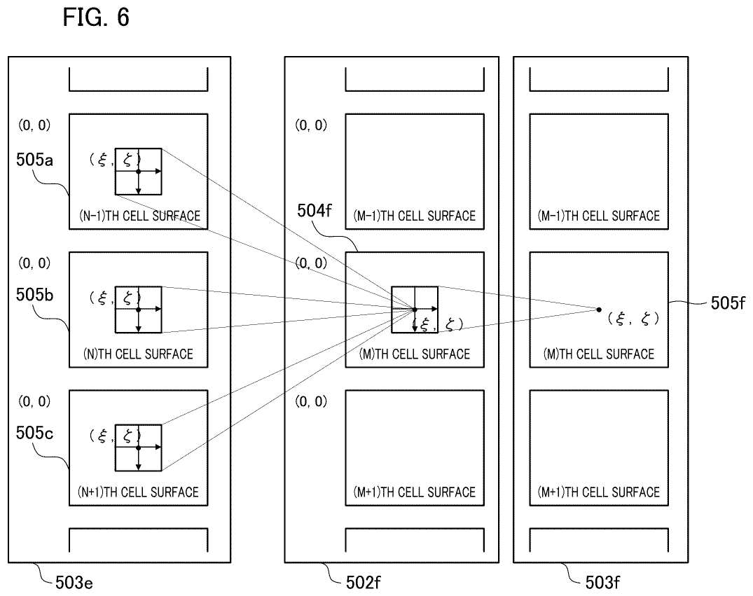

The subject detection unit 405 performs subject detection and extracts a region where a specific subject is present. The subject detection unit 405 applies the ML dictionary recorded in the recording unit 404 and determines a subject region in which a subject classified into a predetermined class is present. The subject detection unit 405 corresponds to a region extraction unit in the second embodiment and the fourth embodiment. Note that only the subject detection may be performed by the subject detection unit 405, and the processing of extracting the region corresponding to the subject may be performed by the image processing unit 401. Here, in a use case in which the user is assumed to use the image processing apparatus 100, it is preferable that, in the predetermined class, a subject having a particularly high importance is set. For example, in a case in which the use case is walking, driving a vehicle, and the like, the subject classified into the predetermined class is a pedestrian, a bicycle, a motorcycle, an automobile, and the like. The subject detection processing in the subject detection unit 405 is realized by, for example, feature extraction processing by deep neural networks (DNN). The configuration of the subject detection unit 405 will be described in detail below with reference to FIG. 5 and FIG. 6.

The power supply management unit 406 performs management of the power supply unit 407. The power supply unit 407 is managed by the power supply management unit 406, and performs power supply to the entire image processing apparatus 100. The bus 408 is a bus that connects each unit inside the control unit 105 and each unit outside the control unit 105.

Next, a configuration of the subject detection unit 405 will be explained with reference to FIG. 5 and FIG. 6. Although, in the present embodiment, an example in which the subject detection unit 405 is configured by convolutional neural networks (CNN) will be explained, the present invention is not limited thereto. A subject detection method performed by the subject detection unit 405 may be any method provided that the method can accurately detect a subject of a predetermined classification.

FIG. 5 is an explanatory view of an example of an overall configuration of the convolutional neural network (CNN) in the subject detection unit 405. In the CNN, two layers referred to as a feature detection layer (S layer) and a feature integration layer (C layer) are set as one set, and the layers are hierarchically configured. In subject detection performed by the subject detection unit 405, a subject is detected from the input two dimensional image data. In the flow of the subject detection processing, in FIG. 5, the left end is set as an input, and the processing proceeds in the right direction. An input image 501, which is two-dimensional image data, is input to the subject detection unit 405.

In FIG. 5, the input image 501 indicates image data that is input to the subject detection unit 405, an S layer 502 indicates a feature detection layer, a C layer 503 indicates a feature integration layer, a feature detection cell surface 504 indicates a cell surface of the S layer, and a feature integration cell surface 505 indicates a cell surface of the C layer. In the CNN, first, the next feature is detected in the S layer, which is a feature detection layer, based on the feature detected in the previous layer. In addition, the CNN has a configuration in which the feature detected in the S layer is integrated in the C layer, and is sent to the next layer as a detection result in that layer. For example, in the S layer 502a, which is the first S layer to which the input image 501 is input, features are detected from the input image 501 and output to the C layer 503a. The C layer 503a integrates the feature detected in the S-layer 502a, and the integrated features are sent to the S-layer 502b of the next layer. In the S layer 502b, a feature is detected based on the feature detected in the C layer 503a, and the feature is output to the C layer 503b. Similar processing is repeated in each layer, the feature detected in the S layer 502c of the (n−1) th layer is integrated in the C layer 503c, and the feature detected in the S layer 502d of the (n) th layer, which is the output layer, becomes a subject detection result.

The S layer has a feature detection cell surface 504, and different features are detected for each feature detection cell surface. Additionally, the C layer has the feature integration cell surface 505, and the detection result in the feature detection cell surface 504 of the previous stage is pooled. Hereinafter, in a case in which there is no particular need to distinguish the feature detection cell surface 504 and the feature integration cell surface 505, they are collectively referred to as feature surfaces. It should be noted that in the present embodiment, the output layer, which is the final stage layer, is configured by only the S layer without using the C layer.

Details of the feature detection processing on the feature detection cell surface and the feature integration processing on the feature integration cell surface will be explained with reference to FIG. 6. FIG. 6 is an explanatory view of an example of a partial configuration of the CNN in the subject detection unit 405. The feature detection cell surface 504 is configured by a plurality of feature detection neurons. The feature detection neurons are connected to the C layer 503 of the preceding layer in a predetermined structure. The feature integration cell surface 505 is configured by a plurality of feature integration neurons. The feature integration neurons are connected to the S layer 502 of the same layer in a predetermined structure.

In FIG. 6, as an example of the layers, a C layer 503e that is a feature integration layer on the (L−1) th layer, an S layer 502f that is a feature detection layer on the (L) th layer, and a 503f that is a feature integration layer on the (L) th layer are illustrated. As a part of the feature integration cell surface 505 of the C layer 503e on the (L−1) th layer, the feature integration cell surfaces 505 on the (n−1) th to (n+1) th are shown. A feature integration cell surface 505a is the (n−1) th feature integration cell surface of the C layer 503e. The feature integration cell surface 505b is the (n) th feature integration cell surface of the C layer 503e. The feature-integrated cell-surface 505c is the (n+1) th feature integration cell surface of the C layer 503e. As a part of the feature detection cell surface 504 of the S layer 502f on the L layer, the feature detection cell surfaces 504 from the (M−1) th to the first (M+1) th are shown. The feature detection cell surface 504f is the (M) th feature detection cell surface of the S layer 502f. As a part of the feature integration cell surface 505 of the C layer 503f on the (L) th layer, the feature integration cell surfaces 505 from the (M−1) th to the (M+1) th are shown. The feature integration cell surface 505f is the (M) th feature integration cell surface on the C layer 503f.

In FIG. 6, y_{M}^{LS} (ξ, ζ) represents the outputs of the feature detection neuron at the position (ξ, ζ) in the feature detection cell surface 504f of the Slayer 502f, and y_{M}^{LC} (ξ, ζ) represents the outputs of the feature integration neuron at the position (ξ, ζ) in the feature integration cell surface 505f of the C layer 503f. At this time, assuming that the coupling coefficients of each of the neurons are w_{M}^{LS} (n, u, v) and w_{M}^{LC} (u, v), each output value can be expressed by the following Formulae (1) and (2).

$$[ Formula 1 ]$$

$${y}_{M}^{L S} ( ξ , ζ ) ≡ f ( {u}_{M}^{L S} ( ξ , ζ ) ) ≡ f \{ {\sum }_{n , u , v} {w}_{M}^{L S} ( n , u , v ) \cdot {y}_{n}^{L - 1 C} ( ξ + u , ζ + v ) \} \qquad ( 1 )$$

$$[ Formula 2 ]$$

$${y}_{M}^{LC} ( ξ , ζ ) ≡ {u}_{M}^{L C} ( ξ , ζ ) ≡ {\sum }_{u , v} {w}_{M}^{L C} ( u , v ) \cdot {y}_{M}^{L S} ( ξ + u , ζ + v ) \qquad ( 2 )$$

In Formula (1), f is an activation function, and may be any sigmoid function such as a logistic function and a hyperbolic tangent function, and may be realized by, for example, a tanh function. u_{M}^{LS} (ξ, ζ) indicates the internal state of the feature detection neuron at position (ξ, ζ) in the feature detection cell surface 504f on the S layer 502f. In Formula (2), a simple linear sum without using an activation function is taken. In a case in which the activation function is not used as in Formula (2), the internal state u_{M}^{LC} (ξ, ζ) of the neuron is equal to the output value y_{M}^{LC} (ξ, ζ). Additionally, yₙ^{(L-1C)} (ξ+u, ζ+v) in Formula (1) is referred to as a connection destination output value of the feature detection neuron, and y_{M}^{LS} (ξ+u, ζ+v) in Formula (2) is referred to as a connection destination output value of the feature integration neuron.

ξ, ζ, u, v and n in Formula (1) and Formula (2) will be explained. The position (ξ, ζ) corresponds to the position coordinates in the input image. For example, a case in which y_{M}^{LS} (ξ, ζ) is a high output value means that there is a high possibility that a feature to be detected in the feature detecting cell surface 504f of the S layer 502f exists at the pixel position (ξ, ζ) of the input image. In addition, n in Equation (2) indicates the feature integration cell surface 505b of the C layer 503e and is referred to as an integration destination feature number. Basically, in the S layer 502f that is the L-th layer, the product-sum operation is performed on all the cell surfaces existing in the C layer 503e that is the (L−1) th layer. (u, v) is a relative position coordinate of the coupling coefficient, and the product-sum operation is performed in a finite range (u, v) according to the size of the feature to be detected. Such a finite range of (u, v) is referred to as a reception field. Additionally, the size of the reception field is referred to as a reception field size and is represented by the number of horizontal pixels×the number of vertical pixels within the combined range.

In Formula (1), in L=1, that is, in the first S layer, yₙ^{(L-1C)} (ξ+u, ζ+v) becomes an input image y^{in_image} (ξ+u, +v) or an input position map y^{in_posi_map} (ξ+u, ζ+v). Since the distribution of neurons and pixels is discrete and the connection destination feature numbers are also discrete, ξ, ζ, u, v, and n are not continuous variables but take discrete values. Here, ξ and ζ are non-negative integers, n is a natural number, and u and v are integers, and all take finite ranges.

w_{M}^{LS} (n, u, v) in Formula (1) is a coupling coefficient distribution for detecting a predetermined feature. By adjusting the connection coefficient distribution w_{M}^{LS} (n, u, v) to an appropriate value, it becomes possible to detect a predetermined feature. The adjustment of the coupling coefficient distribution is learning, and in the construction of the CNN, various test patterns are presented, and the coupling coefficient is adjusted by repeatedly and gradually correcting the coupling coefficient so that y_{M}^{LS} (ξ, ζ) becomes an appropriate output value.

w_{M}^{LC} (u, v) in Formula (2) uses a two dimensional Gaussian function and can be expressed by the following Formula (3).

$$[ Formula 3 ]$$

$${w}_{M}^{L C} ( u , v ) = \frac{1}{2 π {σ}_{L , M}^{2}} \cdot exp ( - \frac{{u}^{2} + {v}^{2}}{2 {σ}_{L , M}^{2}} ) \qquad ( 3 )$$

Here as well, since (u, v) is defined within a finite range, similar to the explanation of feature detection neurons, this finite range is referred to as a receptive field, and the size of the range is referred to as the reception field size. Here, the reception field size may be set to an appropriate value according to the size of the feature of the feature detection cell surface 502f on the S layer 504f that is the L-th layer. In Formula (3), σ is a feature size factor and may be set to an appropriate constant according to the reception field size. Specifically, it is preferable to set the outermost value of the reception field to a value that can be regarded as substantially 0. The subject detection processing in the subject detection unit 405 is performed by repeatedly performing the above-described arithmetic operations in each layer and performing subject detection in the S layer 502d, which is the S layer on the final layer of the subject detection unit 405.

Next, a specific learning method of the subject detection unit 405 will be explained. In the present embodiment, adjustment of the coupling coefficient is performed by supervised learning. Supervised learning is a learning method of calculating an optimal model (coefficient) based on input data and correct output data. In the supervised learning in the present embodiment, a test pattern is given to actually obtain an output value of a neuron, and correction of the coupling coefficient w_{M}^{LS} (n, u, v) is performed based on a relation between the output value and a supervisory signal (a desired output value to be output by the neuron).

In the learning of the present embodiment, the least squares method is used for the feature detection layer of the final layer, and the backpropagation method is used for the feature detection layer of the intermediate layer to modify the connection coefficients. In the subject detection unit 405, as test patterns for learning, many specific patterns to be detected and patterns not to be detected are prepared. Each test pattern consists of one set of an image and a teacher signal. In a case in which the tanh function is used as the activation function, when a specific pattern to be detected is presented, a teacher signal is given to neurons in a region in which the specific pattern of the feature detection cell surface of the final layer exists so that the output becomes 1. In contrast, when a pattern not to be detected is presented, a teacher signal is given to the neurons in the region of the pattern not to be detected so that the output becomes −1. In actual subject detection, arithmetic operations are performed using the coupling coefficient w_{M}^{LS} (n, u, v) constructed by learning, and if the neuron output on the feature detection cell surface of the final layer is equal to or larger than a predetermined value, it is determined that a subject is present there. In this manner, the subject detection unit 405 is configured to be able to detect a subject from a two-dimensional image.

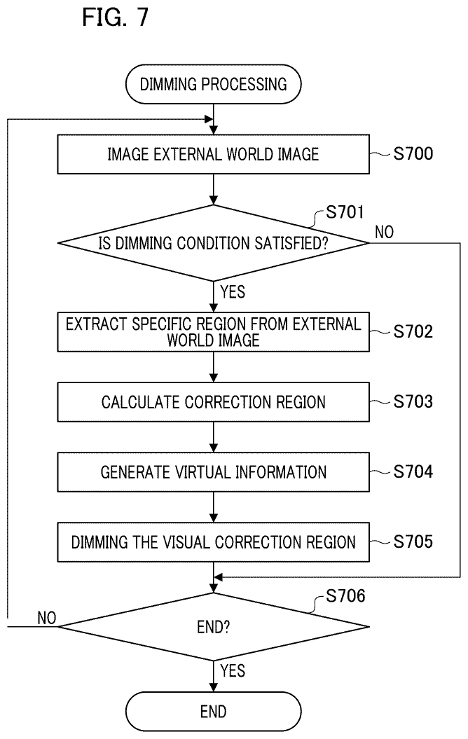

Next, light adjustment processing for chromatic vision correction according to the first embodiment will be explained with reference to FIG. 7. In the present embodiment, the chromatic vision of the user of the image processing apparatus 100 having a chromatic vision characteristic that is different from a normal chromatic vision characteristic is corrected by performing chromatic vision correction in which a virtual image generated by the image processing apparatus 100 is displayed superimposed onto transmitted external light. FIG. 7 is a flowchart illustrating the dimming processing. Processing in each step is executed by the CPU of the control unit 105 according to a program stored in the recording unit 404 that serves as a memory. The processing may be started, for example, in a case in which the image processing apparatus 100 detects that the user has provided an instruction to start chromatic vision correction to the operation portion 104, or in a case in which the image processing apparatus 100 detects that the image processing apparatus 100 has been worn by the user.

First, in step S700, the external world is imaged by the near-eye unit 101. Specifically, image signals generated by imaging the external light in each of the imaging units 209 of the near-eye unit 101a and the near-eye unit 101b are output to the image processing unit 401. Then, in the image processing unit 401, image processing is performed on the image signal to generate an external-world image, and the external image is recorded in the temporary recording unit 403.

In step S701, the control unit 402 performs determination of whether or not the dimming condition is satisfied. In the present embodiment, the control unit 402 performs determination as to the following three conditions as the dimming conditions for performing chromatic vision correction.
(1) Chromatic vision characteristic information corresponding to a user is stored in the recording unit 404 in advance.
(2) In the chromatic vision characteristic information, there is a color tone for which the chromatic vision sensitivity is low.
(3) An instruction to perform chromatic vision correction is provided in advance by the user through the operation portion 104.

In a case in which all of the three conditions are satisfied, the control unit 402 determines that the dimming condition is satisfied and performs the process of step S702. In contrast, in a case in which there is a condition that is not satisfied among the three conditions, the control unit 402 determines that the dimming condition is not satisfied, and performs the process of step S706.

The process in each step from step S702 to step S705 is performed for each external-world image captured by the imaging part 209 of each of the near-eye unit 101a and the near-eye unit 101b. In step S702, the image processing unit 401 extracts a specific region from the external image. In this context, the specific region is a region having a luminance value equal to or greater than a predetermined value corresponding to a color tone in which the chromatic vision sensitivity of the user is low (color information that is difficult to perceive) based on the chromatic vision characteristic information. In the present embodiment, the dimming operation is partially performed on a specific region that is a region with a color tone in which the chromatic vision sensitivity of the user is low. Accordingly, the image processing unit 401 extracts, as a specific region, a region having color information that is difficult to perceive in terms of chromatic vision from the external image.

In step S703, the virtual image generation unit 400 calculates a correction region corresponding to the extraction region. In this context, the correction region refers to a region in the coordinates system of the virtual image display portion 203 corresponding to the extraction region in the external-world image extracted in step S702. In the present embodiment, since the three optical axes of the optical axis of the eyeball 200, the optical axis of the virtual image display portion 203, and the optical axis of the imaging part 209 are equal, resulting in a structure without parallax. Therefore, when the image magnifications and the pixel ratios of the virtual image display portion 203 and the imaging part 209 are set to be equal, the coordinate system of the external image and the coordinate system of the virtual image display unit 203 correspond such that pixels at the same coordinates correspond to each other. Even in a case in which the image magnification and the pixel ratio are different, the correction region can be easily calculated by multiplying the distance from the center pixel to the pixel of interest by the image magnification and the pixel ratio.

In step S704, the virtual image generation unit 400 generates virtual image information for display in the virtual image display portion 203. The virtual image information is pixel information of a virtual image with respect to the display element of the virtual image display portion 203. A specific method of generating the virtual image information will be described below. Next, in step S705, the virtual image display unit 203 corrects the vision of the user by displaying a virtual image and dimming the vision correction region. Specifically, the virtual image display portion 203 corrects the vision of the user by displaying the virtual image based on the correction region calculated in step S703 and the virtual image information generated in step S704.

Next, in step S706, the control unit 402 performs determination of whether or not the user has provided an instruction to end chromatic vision correction to the operation portion 104. In a case in which the instruction to end the chromatic vision correction is received from the user, the series of dimming processing ends. In contrast, in a case in which the instruction to end the dimming is not received from the user, the process returns to step S700, and the dimming processing continues.

In this context, a generation method of virtual image information for chromatic vision correction performed by the virtual image generation unit 400 in step S704 will be explained. In the present embodiment, for each pixel of the correction region calculated in step S703, the virtual image information is generated using the pixel information of the specific region that has been extracted from the corresponding external-world image and the chromatic vision characteristic information of the user recorded in the recording unit 404. The virtual image information can be calculated by the following Formula (4).

$$[ Formula 4 ]$$

$${I}_{I} ( x , y ) = \frac{1}{n} \frac{1}{m} {\sum }_{i = 0}^{n - 1} {\sum }_{j = 0}^{m - 1} {I}_{R} ( i , j ) ( \frac{1}{T} - 1 ) \qquad ( 4 )$$

I_{I} (x, y) is pixel information at coordinates (x, y) in the correction region in the virtual image. I_{R} (i, j) is pixel information at coordinates (i, j) corresponding to the coordinates (x, y) of the correction region in the specific region in the external-world image. “n” is the number of pixels in the i-direction in a specific region of the external-world image, and “m” is the number of pixels in the j-direction in a specific region of the external-world image. Additionally, the coordinates (x, y) in the correction region in the virtual image correspond to the region from 0 to n in the i direction and from 0 to m in the j direction in the specific region in the external-world image. T is chromatic vision characteristic information of the user.

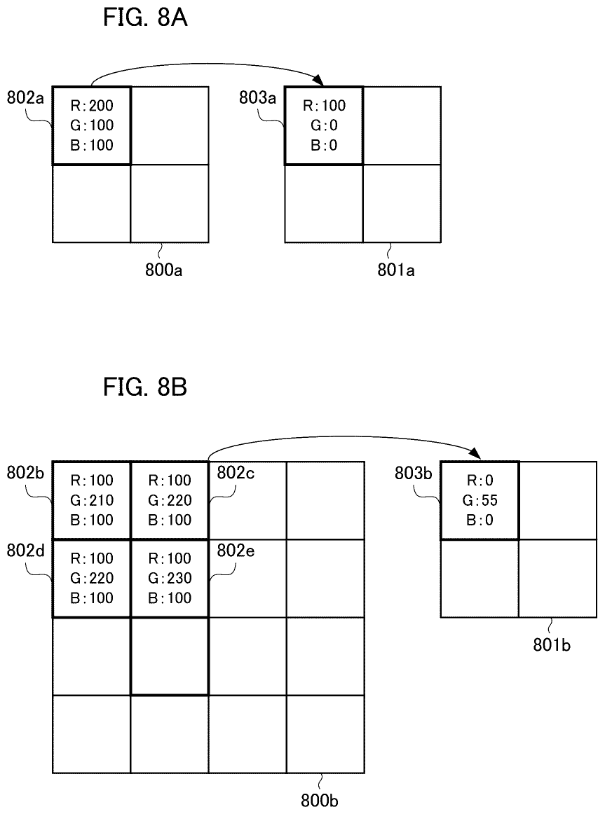

Here, an example of virtual image information generation for chromatic vision correction will be explained with reference to FIG. 8A and FIG. 8B. FIG. 8A and FIG. 8B are explanatory views of an example of virtual image information generation in the first embodiment. First, a case in which the image magnification and the pixel ratio of the virtual image display portion 203 are equal to those of the imaging part 209 will be explained. FIG. 8A is an example of a case in which the image processing apparatus 100 is configured such that the coordinate systems of the external-world image and the virtual image have a one-to-one relationship. In a case in which the coordinate systems of the external-world image and the virtual image are one to-one, both n and m are 1. A specific region 800a is a region extracted from the external-world image in step S702. A correction region 801a is a correction region corresponding to the specific region 800a. A pixel 802a is one pixel in the specific region 800a. A pixel 803a is one pixel of the correction region 801a and corresponds to the pixel 802a.

Here, it is assumed that the chromatic vision characteristic information T is 0.5 for R, 1 for G, and 1 for B, and the sensitivity for red is low. In a case in which the sensitivity of the user with respect to red is low, that is, in a case in which the color information with difficulty in chromatic vision is red, the chromatic vision for red is corrected to make the red easily visible. The pixel values of RGB at the pixel 802a are set as R=200, G=100, and B=100. The pixel 803a is calculated by applying Formula (4) to each of the RGB pixel values of the pixel 802a. The pixel values of RGB at the pixel 803a are set as R=100, G=0, and B=0. By similarly performing the calculation process according to Formula (4) on all the pixels of the specific region 800a based on the chromatic vision characteristic information of the user, all the pixel information of the correction region 801a that is the virtual image information is generated.

Next, a case in which the image magnification and the pixel ratio of the virtual image display portion 203 are different from those of the imaging part 209 will be explained. Even when the image magnification and the pixel ratio are different between the virtual image display portion 203 and the imaging part 209, the correction region can be easily calculated by multiplying the distance from the center pixel to the pixel of interest by the image magnification and the pixel ratio. FIG. 8B is an example of a case in which the image processing apparatus 100 is configured such that the coordinate systems of the external image and the virtual image are 2:1. In a case in which the coordinate systems of the external-world image and the virtual image are 2:1, both n and m are 2.

A specific region 800b is a region extracted from the external-world image in step S702. The correction region 801b is a correction region corresponding to the specific region 800b. Each of the pixel 802b, a pixel 802c, a pixel 802d, and the pixel 802e is one pixel in the specific region 800b. The lower side of the pixel 802b is adjacent to the upper side of the pixel 802d, the right side of the pixel 802b is adjacent to the left side of the pixel 802c, the right side of the pixel 802d is adjacent to the left side of the pixel 802e, and the lower side of the pixel 802b is adjacent to the upper side of the pixel 802e. A pixel 803b is one pixel of the correction region 801b, and corresponds to four pixels of the pixel 802b, the pixel 802c, the pixel 802d, and the pixel 802e.

Here, it is assumed that the chromatic vision characteristic information T is 1 for R, 0.8 for G, and 1 for B, and the sensitivity for green is low. In a case in which the sensitivity of the user for green is low, the chromatic vision for green is corrected so that green is made easily visible. It is assumed that the pixel values of RGB at the pixel 802b are set as R=100, G=210, and B=100. It is assumed that the pixel values of RGB at the pixel 802c are set as R=100, G=220, and B=100. It is assumed that the pixel values of RGB at the pixel 802d are set as R=100, G=220, and B=100. It is assumed that the pixel values of RGB at the pixel 802e are set as R=100, G=230, and B=100. The pixel 803b is calculated by applying Formula (4) to each of the RGB pixel values of the pixel 802b, the pixel 802c, the pixel 802d, and a pixel 802e. The pixel values of RGB at the pixel 803b are set as R=0, G=55, and B=0. By similarly performing the calculation process according to Formula (4) on all the pixels of the specific region 800b based on the chromatic vision characteristic information of the user, all the pixel information of the correction region 801b that is the virtual image information is generated.

Note that in Formula (4), although the pixel value of the corresponding correction region is calculated using the average value from the n×m pixel values in the specific region of the external-world image, the present invention is not limited thereto. For example, the virtual image information may be generated by deforming the specific region into the correction region using a known enlargement and reduction method such as a nearest neighbor method, a bi-cubic method, or a pixel interpolation technology by Deep Learning.

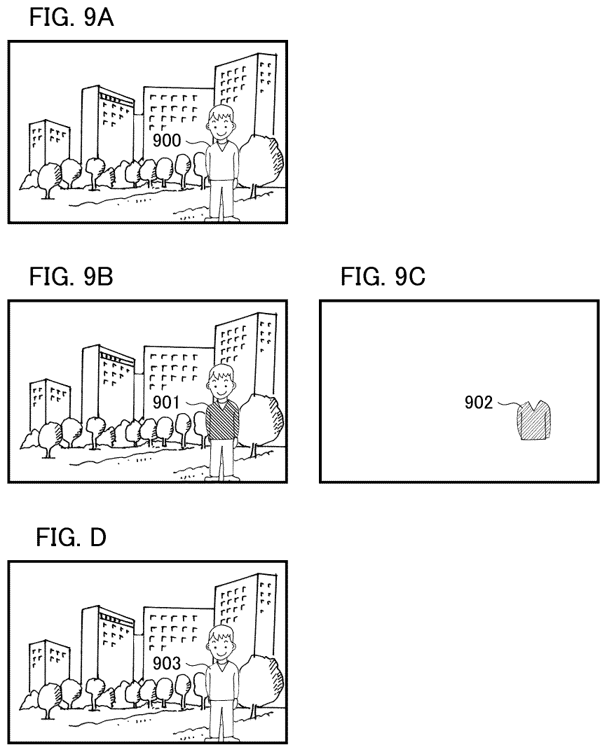

Finally, an application example of the chromatic vision correction in the present embodiment will be explained with reference to FIGS. 9A to 9D. FIG. 9A to FIG. 9D are diagrams illustrating an application example of chromatic vision correction according to the first embodiment. FIG. 9A shows an external-world image. Here, the region 900 corresponding to the jacket worn by the person who is the subject is assumed to be a region of a color tone (for example, red) for which sensitivity is low according to the chromatic vision characteristic information of the user. FIG. 9B shows an image that is visually perceived by the user with only the naked eye. The user visually perceives a different color tone in the region 901, corresponding to the region 900, compared to the region 900 of the external-world image.

FIG. 9C illustrates a virtual image for chromatic vision correction provided by the image processing apparatus 100. The image processing apparatus 100 performs dimming processing and generates virtual image information for correcting the region 901 that is a visual correction region (step S704). Then, the image processing apparatus 100 performs dimming operation by displaying a virtual image of a region 902 corresponding to the region 901 by the virtual image display portion 203 of each of the near-eye unit 101a and the near-eye unit 101b, thereby performing visual correction (S705).

FIG. 9D is an image in which the chromatic vision visually perceived by the user is corrected using the image processing apparatus 100 that performs the dimming processing. By partially visually perceiving the virtual image of the region 902 generated by the image processing apparatus 100 so as to be superimposed onto the transmissive image of the external world region 900, the user can visually perceive the image in which the region 903 has been corrected for chromatic vision corresponding to the external image. That is, a part of the external light as illustrated in FIG. 9A is transmitted through the image processing apparatus 100, and the virtual image illustrated in FIG. 9C is output from the virtual image display portion 203 and superimposed on the external light to be visually perceived by the user.

As described above, according to the present embodiment, chromatic vision correction can be performed by generating a virtual image for compensating for the color tones with low sensitivity for the user, and by superimposing the external light and the virtual image by projecting the virtual image into the image processing apparatus 100 through which the external light passes. Accordingly, even a user having a chromatic vision characteristic different from a normal chromatic vision characteristic can visually perceive an image without parallax between the external world and the virtual image because the chromatic vision is corrected to be equivalent to that of a user having a normal chromatic vision characteristic.

### Second Embodiment

In the first embodiment, the dimming processing for chromatic vision correction has been explained. In the second embodiment, the dimming processing for night vision correction in an image processing apparatus through which external light passes will be explained as visual correction. Note that, as in the first embodiment, also in the image processing apparatus of the second embodiment, it is assumed that the three optical axes of the optical axis of the imaging of the external light, the optical axis of the vision of the external light, and the optical axis of the output of the virtual image light are arranged so as to be identical. Additionally, since the overall configuration of the imaging apparatus, the configuration of the near-eye unit, the optical paths of the external light and the virtual image light, the configuration of the imaging unit, the configuration of the control unit, the configuration of the subject detection unit, and the learning method of the subject detection unit in the present embodiment are similar to those in the first embodiment, the explanation thereof will be omitted. Hereinafter, a difference from the first embodiment will be explained.

A flow of the dimming processing for night vision correction of the image processing apparatus 100 according to the second embodiment will be explained with reference to FIG. 7. In the present embodiment, night vision correction in which a virtual image generated by the image processing apparatus 100 is displayed superimposed onto the transmitted external light is performed, thereby improving the identifiability of an important subject image assumed depending on the use environment even under night vision. The process in each step of FIG. 7 is executed by the CPU of the control unit 105 according to a program stored in the recording unit 404 that serves as a memory. This processing may be started, for example, in a case in which the image processing apparatus 100 detects that the user has provided an instruction to start night vision correction to the operation portion 104, or in a case in which the image processing apparatus 100 detects that the image processing apparatus 100 is worn by the user.

The imaging processing of the external-world image in step S700 is similar to that in step S700 of the first embodiment. In step S701, the control unit 402 determines whether or not a dimming condition for performing night vision correction is satisfied. In the present embodiment, the control unit 402 performs the determination as to the following two conditions as the dimming conditions.
(1) Based on the image information of the external image, the environment has low identifiability (difficult for the user to be visually perceived).
(2) Has the user instructed to perform night vision correction in advance through the operation portion 104? The fact that the environment has low identifiability, that is, an environment where the user has difficulty in visual perception, indicates that the usage environment of the image processing apparatus 100 is under night vision conditions. The determination as to whether or not the environment has low identifiability and the user has difficulty in visual perception is evaluated by, for example, a pixel value (luminance value) of the entire external image. Specifically, in a case in which the total sum of the pixel values of the entire external-world image is less than a predetermined value, the control unit 402 determines that the environment is an environment where the user has difficulty in visual perception. Alternatively, the image processing apparatus 100 may include an illuminance meter (not illustrated) and the control unit 402 may determine that the environment is an environment where the user has difficulty in visual perception in a case in which the illuminance measured by the illumination meter is less than a predetermined illuminance. In a case in which both of the two conditions are satisfied, the control unit 402 determines that the dimming condition is satisfied and performs the process of step S702. In contrast, in a case in which there is a condition that is not satisfied among the two conditions, the control unit 402 determines that the dimming condition is not satisfied and performs the process of step S706.

The process in each step from S702 to step S705 is performed for each external-world image captured by the imaging part 209 of each of the near-eye unit 101a and the near-eye unit 101b. In step S702, the subject detection unit 405 extracts a specific region from the external-world image. In this context, the specific region refers to a subject region corresponding to a predetermined subject. The predetermined subject refers to a subject that has been set in advance as particularly important in the use case. For example, in a case in which the use case is walking, driving a vehicle, and the like, a pedestrian, a bicycle, a motorcycle, and an automobile are set as the predetermined subject. In the present embodiment, in an environment with low visibility such as dark vision, a region corresponding to a subject as particularly important is partially dimmed and displayed to improve the visibility.

In step S703, the virtual image generation unit 400 calculates a correction region corresponding to the extraction region. Here, the correction region refers to a region in the coordinate systems of the virtual image display portion 203 corresponding to the specific region in the external-world image that has been extracted in step S702. In the present embodiment, since the three optical axes of the optical axis of the eyeball 200, the optical axis of the virtual image display portion 203, and the optical axis of the imaging part 209 are equal, resulting in a structure without parallax. Therefore, when the image magnifications and the pixel ratios of the virtual image display portion 203 and the imaging part 209 are set to be equal, the pixels of the same coordinates in the coordinate systems of the external image and the virtual image display unit 203 correspond to each other. Even in cases in which the image magnification and the pixel ratio are different, the correction region can be easily calculated by multiplying the distance from the center pixel to the pixel of interest by the image magnification and the pixel ratio.

In step S704, the virtual image generation unit 400 generates virtual image information to be displayed by the virtual image display portion 203. The virtual image information is pixel information of a virtual image corresponding to the display element of the virtual image display portion 203. A generation method of virtual image information for night vision correction in step S704 according to the second embodiment will be explained. In the present embodiment, the virtual image generation unit 400 generates virtual image information by using pixel information of the specific region extracted from the outside world image corresponding to each pixel of the correction region calculated in step S703, and the night vision correction coefficient calculated by the image processing unit 401. The virtual image information can be calculated by the following Formula (5). Note that decimal fractions of the pixel values of the virtual image information are discarded.

$$[ Formula 5 ]$$

$${I}_{I} ( x , y ) = α \frac{1}{n} \frac{1}{m} {\sum }_{i = 0}^{n - 1} {\sum }_{j = 0}^{m - 1} {I}_{R} ( i , j ) \qquad ( 5 )$$

Since each element other than α are the same as those in the first embodiment, the explanation thereof will be omitted. α is a night vision correction coefficient and can be calculated by the following Formula (6).

$$[ Formula 6 ]$$

$$α = β \frac{{I}_{Rout MAX}}{{I}_{Rin\_MAX}} \qquad ( 6 )$$

β is the maximum dark vision correction factor recorded in the recording unit 404. The maximum dark vision correction rate β indicates a ratio of the night vision correction to the maximum amount of light that can be output by the virtual image display portion 203 in a case in which the night vision correction is performed. The maximum night vision correction factor β is expressed from 1 to 0, wherein 1 indicates that the night vision correction is performed to the maximum, and 0 indicates that the night vision correction is not performed. I_{Rout_MAX} is a maximum pixel value of any of RGB that can be output in the virtual image display portion 203. I_{Rin_MAX} is the maximum pixel value of any one of RGB among the pixel values of the specific region in the external-world image. By setting I_{Rin_MAX} in this manner, the pixel values of all the color elements of all the pixels in the correction region are controlled so as not to exceed the pixel value determined by the maximum night vision correction factor. Additionally, the distribution tendency of the pixel information of the specific region is maintained by calculating the pixel I_{I} (x, y) using the shared night vision correction coefficient α for the entire correction region.

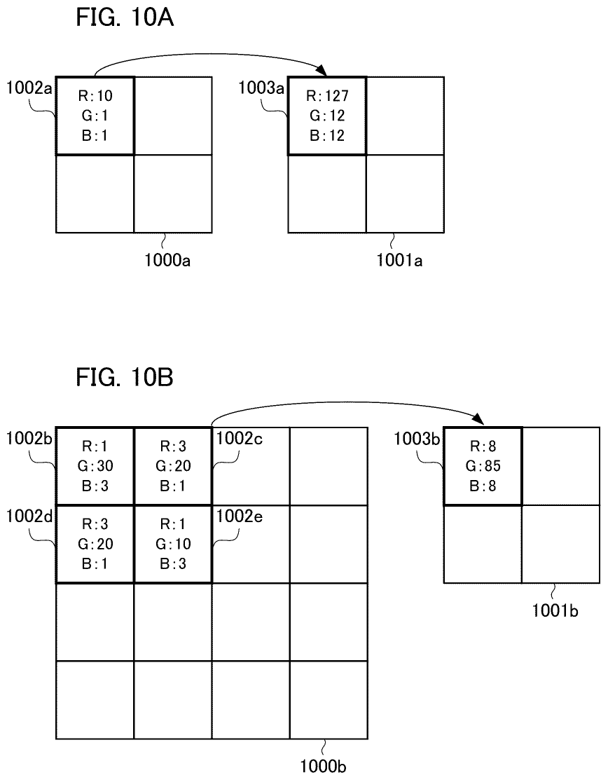

Here, an example of generation of virtual image information for dark vision correction will be explained with reference to FIGS. 10A and 10B. FIGS. 10A and 10B are explanatory views of an example of the generation of virtual image information in the second embodiment. First, an explanation is provided with respect to a case in which the image magnification and pixel ratio of the virtual image display portion 203 and the imaging part 209 are equal. FIG. 10A is an example of a case in which the image processing apparatus 100 is configured such that the coordinate systems of the external-world image and the virtual image are one to-one. The specific region 1000a is a region that has been extracted from the external-world image in step S702. The correction region 1001a is a correction region corresponding to the specific region 1000a. A pixel 1002a is one pixel within the specific region 1000a. The pixel 1003a is one pixel of the correction region 1001a, and the pixel 1003a corresponds to the pixel 1002a.

To generate the correction region of the virtual image from the specific region of the external-world image, Formula (5) and Formula (6) are applied to each of the pixel values of RGB indicated in the pixel 1002a. For example, it is assumed that the pixel values of RGB of the pixel 1002a are set as R=200, G=100, and B=100. It is assumed that the maximum night vision correction factor β is 0.5, I_{Rout_MAX} is 255, and I_{Rin_MAX} is 10, which is the pixel value of the color element R of the pixel 1002a. The night vision correction coefficient α is α=0.5×255/10=12.75 by Formula (6). When Formula (5) is applied to each of the pixel values of RGB indicated in the pixel 1002a, the pixel values of RGB in the pixel 1003a are set as R=127, G=12, and B=12. Here, in the pixel values, the digits below the decimal point are rounded down. By performing the same processing on all the pixels in the specific region 1000a, all pixel information of the correction region 1001a is generated.

Next, an explanation is provided with respect to a case in which the image magnification and pixel ratio of the virtual image display portion 203 and the imaging part 209 are different. Even when the image magnification and the pixel ratio are different between the virtual image display portion 203 and the imaging part 209, the correction region can be easily calculated by multiplying the distance from the center pixel to the pixel of interest by the image magnification and the pixel ratio. FIG. 10B is an example of a case in which the image processing apparatus 100 is configured such that the coordinate systems of the external-world image and the virtual image become 2:1.

The specific region 1000b is a region extracted from the external-world image in step S702. The correction region 1001b is a correction region corresponding to the specific region 1000b. Each of a pixel 1002b, a pixel 1002c, the pixel 1002d, and a pixel 1002e is one pixel in the specific region 1000b. The pixel 1003b is one pixel of the correction region 1001b, and corresponds to four pixels of the pixel 1002b, the pixel 1002c, the pixel 1002d, and the pixel 1002e.

It is assumed that the pixel values of RGB at the pixel 1002b are set as R=1, G=20, and B=3. It is assumed that the pixel values of RGB at the pixel 1002c are set as R=3, G=20, and B=1. It is assumed that the pixel values of RGB at the pixel 1002d are set as R=3, G=20, and B=1. It is assumed that the pixel values of RGB at the pixel 1002e are set as R=1, G=10, and B=3. It is assumed that β and I_{Rout_MAX} are the same as in FIG. 8A, and I_{Rin_MAX} is the pixel value 30 of the color component G in the pixel 1002b. The dark vision correction coefficient α is α=0.5×255/30=4.25 by Formula (6). The pixel 1003b is calculated by applying Formula (5) to each of the RGB pixel values of the pixel 1002b, the pixel 1002c, the pixel 1002d, and the pixel 1002e. The pixel values of RGB at the pixel 1003b are set as R=8, G=85, and B=8. Here, in the pixel values, the digits below the decimal point are rounded down. By performing the same processing on all the pixels in the extraction region 1000b, all pixel information of the correction region 1001b is generated.

Note that although in Formula (5), the pixel value of the corresponding correction region is calculated using the average value from the n×m pixel values in the extraction region of the external-world image, the present invention is not limited thereto. For example, the virtual image information may be generated by deforming the specific region into the correction region by using a known enlargement and reduction method such as a nearest neighbor method, a bi-cubic method, or a pixel interpolation technology by Deep Learning.

In step S705, the virtual image display portion 203 corrects the vision of the user by displaying a virtual image and performing the dimming operation on the vision correction region. Specifically, the virtual image display portion 203 corrects the vision of the user by displaying the virtual image based on the correction region calculated in step S703 and the virtual image information generated in step S704. In step S706, the control unit 402 performs determination of whether or not the user has instructed the operation portion 104 to end the night vision correction. When the instruction to end the night vision correction is received from the user, the series of light control processing ends. In contrast, when the instruction to end the dimming operation for night vision correction is not received from the user, the process returns to step S700, and the dimming processing for night vision correction continues.

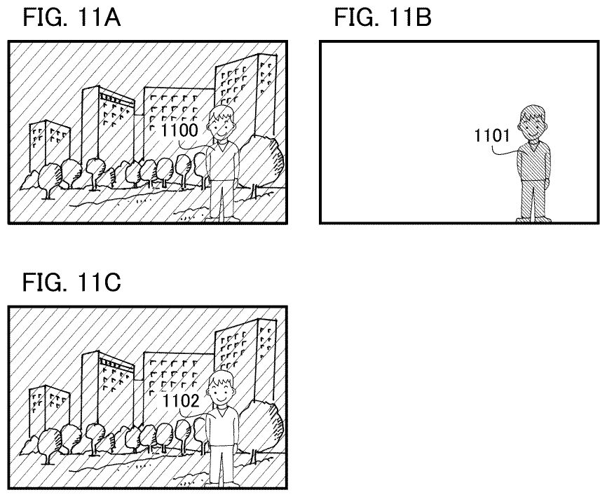

An application example of night vision correction in the present embodiment will be explained with reference to FIGS. 11A to 11C. FIGS. 11A to 11C are explanatory views of an example of virtual image information generation in the second embodiment. FIG. 11A shows an external-world image. A region 1100 is a subject region (specific region) detected by the subject detection unit 405 in step S702. The whole external-world image including the region 1100 is less identifiable with the naked eye because it is under night vision conditions.

FIG. 11B shows a virtual image for night vision correction provided by the image processing apparatus 100. The image processing apparatus 100 performs the dimming processing for night vision correction of the subject region, and generates virtual image information of the region 1101 (S704). Then, the image processing apparatus 100 performs visual correction (S705) by performing the dimming operation through the display of a virtual image in the region 1101, which corresponds to the region 1100 that is the subject region to be corrected, on the virtual image display portions 203 of each of the near-eye unit 101a and the near-eye unit 101b.

FIG. 11C is an image in which night vision correction has been performed that is visually perceived by the user by using the image processing apparatus 100 that performs dimming processing. The user can visually perceive the image with night vision correction for the region 1102 by visually perceiving the virtual image of the region 1101, generated by the image processing apparatus 100, superimposed onto the transmitted image of the region 1100 of the external world. That is, a part of the external light as shown in FIG. 11A is transmitted through the image processing apparatus 100, and the virtual image as shown in FIG. 11B is output from the virtual image display portion 203, is superimposed on the external light, and is visually perceived by the user.

As described above, according to the present embodiment, it is possible to perform dark vision correction by generating a virtual image for improving the identifiability of an important subject image under dark vision, illuminating the virtual image onto the image processing apparatus 100 that transmits external light, and displaying the external light and the virtual image in a superimposed manner. As a result, it is possible to improve the identifiability of the important subject image assumed by the use environment even under night vision, and to allow the user of the image processing apparatus to visually perceive an image without parallax between the external world and the virtual image.

### Third Embodiment

In the first embodiment, the dimming processing by the chromatic vision correction in a case in which the three optical axes of the optical axis of the imaging of the external light, the optical axis of the vision of the external light, and the optical axis of the output of the virtual image light are arranged to be identical has been explained. In the third embodiment, the dimming processing by chromatic vision correction in a case in which two optical axes of an optical axis of vision of external light and an optical axis of output of virtual image light are equally arranged will be explained. That is, in the present embodiment, a case in which the optical axis of the imaging of the external light (the optical axis of the external light corresponding to the imaging unit 1206) is different from the optical axis of the vision of the external light (the optical axis of the eyeball of the user) and the optical axis of the output of the virtual image light (the optical axis of the virtual image light output by a virtual image display part 1303) will be explained. Since the chromatic vision characteristic information, the configuration of the subject detection unit, the learning method of the subject detection unit, the generation method of the virtual image information in the chromatic vision correction, and the specific example of the chromatic vision correction are similar to those in the first embodiment, the explanation thereof will be omitted. Hereinafter, a difference from the first embodiment will be explained.

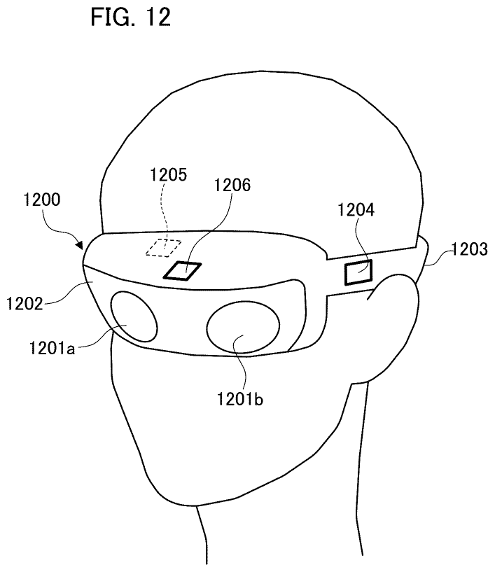

FIG. 12 is a diagram showing the configuration of an image processing apparatus 1200 according to the third embodiment. The image processing apparatus 1200 includes a near-eye unit 1201, a shield 1202, a frame portion 1203, a control unit 1205, and the imaging unit 1206. Additionally, the image processing apparatus 100 may include an operation portion 1204. Since the configurations of the shield 1202, the frame portion 1203, the operation portion 1204, and the control unit 1205 are similar to those of the shield 102, the frame portion 103, the operation portion 104, and the control unit 105 of the first embodiment, the explanation thereof will be omitted. Since the detailed configuration of the control unit 1205 is also similar to that of the control unit 105 of the first embodiment as shown in FIG. 4, the explanation thereof will be omitted.

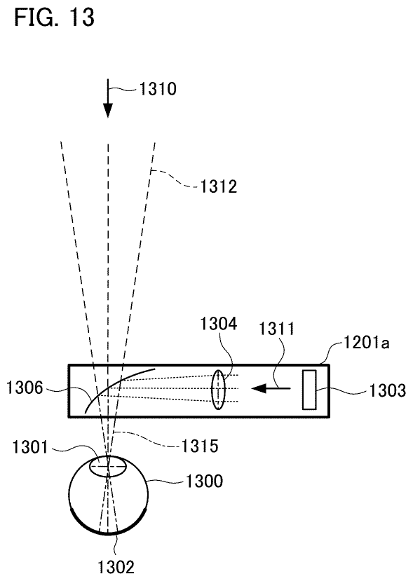

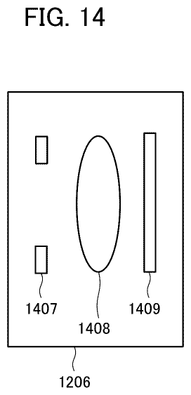

The imaging unit 1206 is a unit that is used for capturing both left and right external-world images in order to generate a virtual image of the near-eye unit 1201 (a near-eye unit 1201a and the near-eye unit 1201b). A detailed configuration of the imaging unit 1206 will be described below with reference to FIG. 14. In the present embodiment, imaging executed by the imaging part 209 of the near-eye unit 101 in the first embodiment is performed by the imaging unit 1206. Therefore, the near-eye unit 1201 of the present embodiment does not include the imaging part 209 and does not have a configuration for guiding light to the imaging part 209. Details of the near-eye unit 1201 of the present embodiment will be explained with reference to FIG. 13.

FIG. 13 is an explanatory view of a configuration of the near-eye unit 1201 according to the third embodiment. FIG. 13 shows a state in which the near-eye unit 1201a is viewed from the top of the head of the human body. In this context, the configuration of the near-eye unit 1201a will be explained as an example, and the near-eye unit 1201b also has the same configuration. The near-eye unit 1201a includes the virtual image display part 1303, a virtual image adjustment part 1304, and an optical path control part 1306. Since the virtual image display part 1303 has the same configuration as the virtual image display portion 203 of the first embodiment, and the virtual image adjustment part 1304 has the same configuration as the virtual image adjustment portion 204 of the first embodiment, the explanation thereof will be omitted. An eyeball 1300 is an eyeball of the user. An iris and a lens 1301 are the iris and the lens of the user. A retina 1302 is the retina of the user.

The optical path control part 1306 is a half mirror having predetermined reflectance and transmittance. The optical path control part 1306 reflects the virtual image that has been output from the virtual image display part 1303. Additionally, the optical path control part 1306 transmits an external light 1310 entering the near-eye unit 1201a via an optical path 1312. The virtual image reflected by the optical path control part 1306 has the same optical axis as the external light transmitted through the optical path control part 1306 and is incident on the eyeball 1300 of the user via an optical path 1315.

Optical paths of the external light 1310 and the virtual image light 1311 controlled by the near-eye unit 1201a will be explained. When passing through the optical path 1312, the external light 1310 enters the near-eye unit 1201a and passes through the optical path control part 1306. The light transmitted through the optical path control part 1306 is incident on the eyeball 1300 of the user via the optical path 1315. The light incident on the eyeball 1300 of the user is refracted by the iris and the lens 1301 and then forms an image on the retina 1302, whereby the user visually perceives the external light.

After the focus adjustment control is performed by the virtual image adjustment part 1304, the virtual image light 1311 emitted from the virtual image display part 1303 is reflected by the optical path control part 1306, have the same optical axis as the external light that has been transmitted through the optical path control unit 1306, and is incident on the eyeball 1300 of the user via the optical path 1315. The light incident on the eyeball 1300 of the user is refracted by the iris and the lens 1301 to form an image on the retina 1314, whereby the user visually perceives a virtual image.

The external light 1310 visually perceived by the eyeball 1300 via the image processing apparatus 1200 of the present embodiment and the virtual image light 1311 displayed by the virtual image display part 1303 have the same optical axis and have a structure without parallax. Therefore, the configuration is suitable for calculation of the correction region. Note that the configuration of the near-eye unit 1201 explained here is an example, and the present invention is not limited thereto, and it suffices if any optical see-through capable of superimposing the external light and the virtual image light with high accuracy is used.

A configuration of the imaging unit 1206 will be explained with reference to FIG. 14. FIG. 14 is an explanatory view of a configuration of an imaging unit 1206 according to the third embodiment. The imaging unit 1206 images external light and outputs the acquired image data to the control unit 1205. The imaging unit 1206 includes a light amount adjustment unit 1407, an optical system 1408, and an imaging part 1409. Since the light amount adjustment unit 1407 has the same configuration as the light amount adjustment portion 207 of the first embodiment, the optical system 1408 has the same configuration as the optical system 208 of the first embodiment, and the imaging part 1409 has the same configuration as the imaging part 209 of the first embodiment, the explanation thereof will be omitted. Additionally, since the pixel structure of the imaging part 1409 is similar to that of the first embodiment (FIGS. 3A and 3B), the detailed explanation thereof will be omitted.

Next, dimming processing for chromatic vision correction in the third embodiment will be explained with reference to FIG. 7. In the present embodiment, the chromatic vision of the user of the image processing apparatus 100 who has a chromatic vision characteristic that is different from a normal chromatic vision characteristic is corrected by performing chromatic vision correction in which a virtual image generated by the image processing apparatus 100 is displayed superimposed manner onto transmitted external light. The process in each step is executed by the CPU of the control unit 105 according to a program stored in the recording unit 404 that serves as a memory.

First, in step S700, the imaging unit 1206 images the external world. Specifically, an image signal generated by imaging the external world by the imaging part 1409 of the imaging unit 1206 is output to the image processing unit 401. Then, in the image processing unit 401, image processing is performed on the image signal to generate an external-world image, and the external image is recorded in the temporary recording unit 403. Additionally, in the present embodiment, a defocus map corresponding to the external-world image is generated in the image processing unit 401 and the defocus map is recorded in the temporary recording unit 403.

The processes of step S701 and step S702 are similar to those in the first embodiment, and the detailed description thereof will be omitted. In a case in which, in step S701, three dimming conditions for performing the dimming operation for chromatic vision correction are satisfied, in step S702, a specific region is extracted from an external image. The specific region is a region having a luminance value equal to or greater than a predetermined value corresponding to a color tone in which the chromatic vision sensitivity of the user is low based on the chromatic vision characteristic information.

In step S703, the virtual image generation unit 400 calculates a correction region corresponding to the extraction region. In this context, the correction region refers to a region in the coordinates system of the virtual image display portion 203 corresponding to the extraction region in the external-world image extracted in step S702. In the present embodiment, the correction region for the virtual image display part 1303 provided in each of the near-eye unit 1201a and near-eye unit 1201b is calculated based on the external-world image captured by the imaging part 1409 that is provided in the imaging unit 1206. Accordingly, in step S703 of the present embodiment, a correction region for each virtual image display part 1303 is calculated. Similarly, in each process of step S703 to step S705 of the present embodiment, a process for each virtual image display part 1303 is performed.

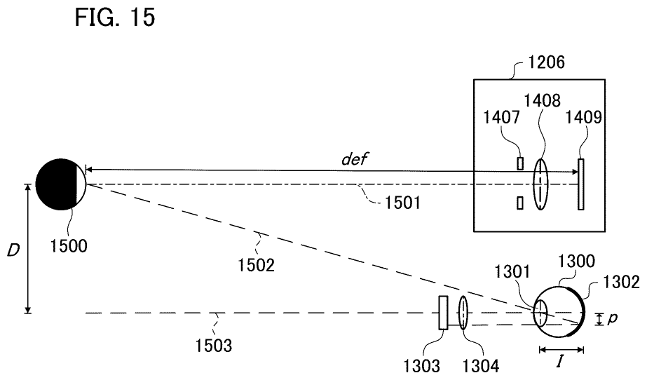

Additionally, in the present embodiment, although the optical axis of the eyeball 1300 and the optical axis of the virtual image display part 1303 are identical, the optical axis of the imaging part 1409 is different, resulting in a configuration with parallax. To correct parallax, a parallax amount and the number of parallax pixels corresponding to the parallax amount are calculated, and a corresponding pixel in a correction region is derived by shifting from a pixel center based on the calculated number of parallax pixels. A calculation method of the parallax amount will be described below with reference to FIG. 15. When the image magnification and pixel ratio of the virtual image display unit 1303 and the imaging unit 1409 are made equal, the coordinate systems of the external-world image and the virtual image display unit 1303 correspond to pixels in which the number of parallel pixels is shifted from the same coordinate. Additionally, even in a case in which the image magnification and the pixel ratio are different, the corresponding pixel can be easily derived by multiplying the distance from a pixel shifted from the center pixel by the number of parallax pixels to a pixel of interest by the image magnification and the pixel ratio.

In step S704, the virtual image generation unit 400 generates virtual image information to be displayed by the virtual image display portion 203. The virtual image information is pixel information of a virtual image corresponding to the display element of the virtual image display portion 203. Since the method of generating the virtual image information is similar to that in the first embodiment, the detailed explanation thereof will be omitted. Next, in step S705, the virtual image display unit 203 corrects the vision of the user by displaying a virtual image and dimming the vision correction region. Specifically, the virtual image display portion 203 corrects the vision of the user by displaying the virtual image based on the correction region calculated in step S703 and the virtual image information generated in step S704. In step S706, the control unit 402 determines whether or not the user has provided an instruction to end the chromatic vision correction to the operation portion 104. In a case in which the instruction to end the chromatic vision correction is received from the user, the series of dimming processing ends. In contrast, in a case in which the instruction to end the dimming is not received from the user, the process returns to step S700, and the dimming processing continues.

Here, a calculation method of the parallax amount in step S703 will be explained with reference to FIG. 15. FIG. 15 is a diagram that explains the calculation of the parallax amount. FIG. 15 schematically illustrates a subject 1500, the imaging unit 1206, the virtual image display part 1303, a virtual image adjustment part 1304, and the eyeball 1300 of the user from the top of the head of the user. The subject 1500 is a subject that is present in a specific region of an external-world image, and the eyeball 1300 is the eyeball of the left eye of the user. There is the near-eye unit 1201b in front of the left eye of the user wearing the image processing apparatus 1200. The iris is the iris of the eyeball 1300, the lens 1301 is the lens of the eyeball 1300, and the retina 1302 is the retina of the eyeball 1300. The light amount adjustment unit 1407, the optical system 1408, and the imaging part 1409 are components of the imaging portion 1206. Additionally, in this context, it is assumed that the virtual image display part 1303 and the virtual image adjustment part 1304 are illustrated at positions that maintain the optical positional relationship, assuming that the virtual image output from the virtual image display unit 1303 enters the eyeball 1300 of the user by proceeding straight without being reflected by the optical path control part 1306.

In the present embodiment, the two optical axes of the optical axis of the vision of the external light and the optical axis of the output of the virtual image light, are arranged to be equal. An optical axis 1501 is the center of the optical axis of the imaging part 1409. An optical axis 1503 is the center of the optical axis of the eyeball 1300 and the center of the optical axis of the virtual image display part 1303. The light emitted at a point on the subject 1500 reaches the center of the optical axis of the imaging element 1409 via the optical axis 1501. Conversely, the light reflected at the same point on the subject 1500 reaches the retina 1302 via the optical path 1502, deviating from the optical axis center (optical axis 1503) by a parallax amount p. There is a parallax of a parallax amount p in the correction region in the coordinate system of the virtual image display portion 203 corresponding to the extraction region of the external-world image that has been captured by the imaging part 1409. At this time, the parallax amount p can be calculated by the following Formula (7).

$$[ Formula 7 ]$$

$$p = \frac{lD}{def - l} \qquad ( 7 )$$

“def” is distance information from the imaging part 1409 to the subject 1500 obtained from the defocus map corresponding to the coordinates of interest in the external-world image. D is a distance between the optical axis center of the imaging part 1409 and the optical axis center of the virtual image display part 1303. Since D is determined by the configuration of the image processing apparatus 100 and is known, D is recorded in the recording unit 404 in advance, and it is used by reading it out. l is the length from the iris of the user and lens 1301 to the retina 1302. As 1, a statistical numerical value of a human body is recorded in the recording unit 404 in advance, and it is used by reading it out. When the parallax amount p is defined as a distance on the virtual image display part 1303, the parallax amount p becomes a parallax pixel number P. The number of parallax pixel number P can be calculated by the following Formula (8).

$$[ Formula 8 ]$$

$$P = \frac{p S}{h} \qquad ( 8 )$$

S is the number of pixels of the virtual image display part 1303. h is the size of the virtual image display part 1303. Since S and h are determined from the configuration of the image processing apparatus 100 and are known, they are recorded in the recording unit 404 in advance and are used by reading them out. According to the above, the parallax amount p and the number of parallax pixels P can be calculated. The virtual image generation unit 400 derives corresponding pixels by shifting from the pixel center based on the parallax pixel number P when calculating the correction region in the coordinate system of the virtual image display unit 203 corresponding to the extraction region of the external image.

As described above, according to the present embodiment, even in a case in which the optical axis of the imaging of the external light is different from the optical axis of the visual image of the external light and the optical axis of the output of the virtual image light, the virtual image in which the position deviation due to the optical axis misalignment has been corrected can be displayed superimposed onto the external light transmitting through the image processing apparatus 100. Then, a virtual image for compensating for color tones with low sensitivity for the user is generated, the virtual image is illuminated onto the image processing apparatus 100 that transmits external light, and the external light and the virtual image are displayed in a superimposed manner, whereby chromatic vision correction can be performed. Accordingly, even a user having a chromatic vision characteristic different from a normal chromatic vision characteristic can visually perceive an image without parallax between the external world and the virtual image because the chromatic vision is corrected to be equivalent to that of a user having a normal chromatic vision characteristic.

### Fourth Embodiment

In the second embodiment, the dimming processing by the night vision correction in a case in which the three optical axes of the optical axis of the imaging of the external light, the optical axis of the vision of the external light, and the optical axis of the output of the virtual image light are arranged to be identical has been explained. In the third embodiment, the dimming processing by night vision correction in a case in which two optical axes of an optical axis of vision of external light and an optical axis of output of virtual image light are arranged to be identical has been explained. That is, in the present embodiment, a case in which the optical axis of the imaging of the external light is different from the optical axis of the vision of the external light and the optical axis of the output of the virtual image light will be explained. Since the entire configuration of the imaging apparatus, the configuration of the near-eye unit, the optical paths of the external light and the virtual image light, the configurations of the imaging unit and the imaging unit, the configuration of the control unit, the configuration of the subject detection unit, the learning method of the subject detection unit, and the parallax correction method are similar to those in the third embodiment, the explanation thereof will be omitted. Additionally, since a generation method of the virtual image information in the night vision correction and a specific example of the night vision correction are similar to those in the second embodiment, the explanation thereof will be omitted.

The dimming processing for night vision correction in the fourth embodiment will be explained with reference to FIG. 7. In the present embodiment, night vision correction in which a virtual image generated by the image processing apparatus 100 is displayed superimposed onto the transmitted external light is performed, thereby improving the identifiability of an important subject image assumed depending on the use environment even under night vision. The processing in each step of FIG. 7 is executed by the CPU of the control unit 105 according to a program stored in the recording unit 404 that serves as a memory.

In step S700, the imaging unit 1206 captures an image of the external world. The processing of step S700 in the present embodiment is similar to the process of step S700 in the third embodiment. In step S701, the control unit 402 determines whether or not the dimming condition is satisfied. The processing of S701 in the present embodiment is similar to the processing of step S701 in the second embodiment. The process of step S702 in the present embodiment is similar to the processing of S703 in the second embodiment. Each processing from step S703 to step S706 in the present embodiment is similar to each processing from step S703 to step S706 in the third embodiment.

As described above, according to the present embodiment, even in a case in which the optical axis of the imaging of the external light is different from the optical axis of the visual image of the external light and the optical axis of the output of the virtual image light, the virtual image in which the position deviation due to the optical axis misalignment has been corrected can be displayed superimposed onto the external light transmitting through the image processing apparatus 100. Then, a virtual image for improving the identifiability of an important subject image under dark vision is generated, and a virtual image is illuminated to the image processing apparatus 100 that transmits the external light, whereby the external light and the virtual image are displayed in a superposed manner. As a result, it is possible to improve the identifiability of the important subject image assumed by the use environment even under night vision, and to allow the user of the image processing apparatus to visually perceive an image without parallax between the external world and the virtual image.

Note that, although in the third embodiment and the fourth embodiment, a case in which the optical axis of the imaging of the external light is different from the optical axis of the vision of the external light and the optical axis of the output of the virtual image light has been explained as an example, the present invention is not limited thereto. It suffices if two of the optical axes of the imaging unit, the optical axis of the virtual image display unit, and the optical axis of the eyeball of the user are identical. In this case, it is possible to correct the parallax based on the arrangement information of at least two or more of the imaging unit, the virtual image display unit, and the eyeball of the user, and determine the position at which the virtual image is to be displayed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-084841, filed May 24, 2024, which is hereby incorporated by reference wherein in its entirety.

What is claimed is:

1. An image processing apparatus capable of allowing a user to visually perceive an image by transmitting external light comprising:
at least one processor and/or circuit configured to function as following units:
an imaging unit configured to capture an image of an external world;
a region extraction unit configured to extract a specific region from an external-world image acquired by imaging by the imaging unit;
a virtual image generation unit configured to generate a virtual image for correcting a vision of a user for the specific region; and
a virtual image display unit configured to display the virtual image so as to be superimposed on a region corresponding to the specific region of the transmitted external light,
wherein the region extraction unit extracts the subject region as a specific region by detecting a subject region corresponding to a predetermined subject from the external image, and
wherein the virtual image generation unit generates a virtual image for correcting the identifiability of the predetermined subject based on pixel information of the specific region and a night vision correction coefficient.

2. The image processing apparatus according to claim 1,
wherein the processor and/or circuit further function as a recording unit configured to record a chromatic vision characteristic of a user,
wherein the region extraction unit extracts, as a specific region, a region having color information in which the chromatic vision sensitivity of the user is low from the external-world image based on the chromatic vision characteristic, and
wherein the virtual image generation unit generates a virtual image for correcting color information in which the chromatic vision sensitivity of the user is low based on the pixel information of the specific region and the chromatic vision characteristics.

3. The image processing apparatus according to claim 1,
wherein the processor and/or circuit further function as a recording unit configured to record a maximum night vision correction factor indicating to what extent night vision correction is performed with respect to a maximum amount of light that can be output by the virtual image display unit,
wherein the region extraction unit extracts the subject region as a specific region in a case in which identifiability of an external world in which a sum of pixel values of the external-world image is less than a predetermined value is low, and
wherein the virtual image generation unit calculates a night vision correction coefficient based on the maximum night vision correction factor, a maximum pixel value that can be output by the virtual image display unit, and a maximum pixel value of the specific region.

4. The image processing apparatus according to claim 1 further comprising an optical path control unit that is a half mirror on an external side that transmits a part of the external light to enter an eyeball of the user, and reflects a part of the external light to enter the imaging unit, and that is a full mirror on an eyeball side that reflects a virtual image illuminated by the virtual image display unit to enter the eyeball, and,
wherein an optical axis of external light corresponding to the imaging unit, an optical axis of virtual image light output by the virtual image display unit, and an optical axis of the eyeball of the user are arranged so as to be identical.

5. The image processing apparatus according to claim 1
wherein two of an optical axis of external light corresponding to the imaging unit, an optical axis of virtual image light output by the virtual image display unit, and an optical axis of the eyeball of the user are arranged so as to be identical with each other, and
wherein a position at which the virtual image is displayed is determined based on arrangement information of at least two or more of the imaging unit, the virtual image display unit, and the eyeball of the user.

6. The image processing apparatus according to claim 5,
wherein the imaging unit outputs a plurality of images having parallax by separately receiving each of the light fluxes that have passed through different pupil regions of an imaging optical system, and
wherein when determining a position at which the virtual image is to be displayed, a distance from the imaging unit to the specific region measured from a plurality of images having parallax is used.

7. The image processing apparatus according to claim 1, wherein a virtual image display unit displays a virtual image by emitting light of at least one or more wavelengths.

8. The image processing apparatus according to claim 1, wherein the image processing apparatus is a head-mounted display.

9. A control method of an image processing apparatus configured to allow a user to visually perceive an image by transmitting external light, the method comprising:
extracting a specific region from an external-world image acquired from an imaging unit configured to capture an image of an external world;
generating a virtual image for correcting vision of a user for the specific region; and
displaying the virtual image so as to be superimposed on a region corresponding to the specific region of the transmitted external light,
wherein when extracting the specific region, the subject region is extracted as a specific region by detecting a subject region corresponding to a predetermined subject from the external image, and
wherein a virtual image for correcting the identifiability of the predetermined subject is generated based on pixel information of the specific region and a night vision correction coefficient.

10. A non-transitory storage medium storing a control program of an image processing apparatus causing a computer to perform each step of a control method of the image processing apparatus, the method comprising:
extracting a specific region from an external-world image acquired from an imaging unit configured to capture an image of an external world;
generating a virtual image for correcting vision of a user for the specific region; and
displaying the virtual image so as to be superimposed on a region corresponding to the specific region of the transmitted external light,
wherein when extracting the specific region, the subject region is extracted as a specific region by detecting a subject region corresponding to a predetermined subject from the external image, and
wherein a virtual image for correcting the identifiability of the predetermined subject is generated based on pixel information of the specific region and a night vision correction coefficient.
